(19) United States
(12) Patent Application Publication
(10) Pub. No.: US 2023/0223622 A1
(43) Pub. Date: Jul. 13, 2023

(54) SECONDARY BATTERY

(71) Applicant: Samsung SDI Co., Ltd, Yongin-si (KR)

(72) Inventors: Shin Jung KIM, Yongin-si (KR); Dae Kyu KIM, Yongin-si (KR); Jong Jun PARK, Yongin-si (KR)

(21) Appl. No.: 18/151,172

(22) Filed: Jan. 6, 2023

(30) Foreign Application Priority Data
Jan. 7, 2022 (KR) 10-2022-0002679

(51) Int. Cl. H01M 50/152; H01M 50/107; H01M 50/593; H01M 50/54; H01M 50/30

(52) U.S. Cl. CPC H01M 50/152; H01M 50/107; H01M 50/593; H01M 50/54; H01M 50/30

(57) ABSTRACT

A secondary battery includes: a cylindrical case; an electrode assembly in the cylindrical case; and a cap plate electrically connected to the electrode assembly and sealing the cylindrical case. The cap plate has a first flat portion at a center of the cap plate, a second flat portion outside the first flat portion, and a vent portion between the first flat portion and the second flat portion, and the vent portion has a thickness smaller than a thickness of the first flat portion or a thickness of the second flat portion.

### CROSS-REFERENCE TO RELATED APPLICATION

This application claims priority to and the benefit of Korean Patent Application No. 10-2022-0002679, filed on Jan. 7, 2022, in the Korean Intellectual Property Office, the entire content of which is incorporated herein by reference.

### BACKGROUND

### 1. Field

Aspects of embodiments of the present disclosure relate to a secondary battery.

### 2. Description of the Related Art

secondary batteries, such as lithium-ion secondary batteries, are used as power sources for portable electronic devices as well as for hybrid vehicles and electric vehicles due to, for example, their high operating voltage and high energy density per unit weight.

Secondary batteries may be classified by shape, such as cylindrical, prismatic, or pouch shaped. For example, a cylindrical secondary battery generally includes a cylindrical case, a cylindrical electrode assembly in the case, an (optional) electrolyte injected into the case to enable movement of lithium ions, and a cap assembly coupled at one side of the case to prevent leakage of the electrolyte and to prevent separation of the electrode assembly.

The above information disclosed in this Background section is for enhancement of understanding of the background of the present disclosure, and therefore, it may contain information that does not constitute prior art.

### SUMMARY

Embodiments of the present disclosure provide a secondary battery exhibiting improved safety by discharging internal gas while preventing deformation of a cap plate, which includes a vent, when pressure inside the case increases.

A secondary battery, according to an embodiment of the present disclosure, includes: a cylindrical case; an electrode assembly in the cylindrical case; and a cap plate electrically connected to the electrode assembly and sealing the cylindrical case. The cap plate has a first flat portion at a center of the cap plate, a second flat portion outside the first flat portion, and a vent portion between the first flat portion and the second flat portion, and the vent portion has a thickness smaller than a thickness of the first flat portion or a thickness of the second flat portion.

The thickness of the first flat portion may be in a range of about 0.7 mm to about 0.9 mm.

An upper surface of the second flat portion may be above an upper surface of the first flat portion in a height direction.

A height difference between the upper surface of the first flat portion and the upper surface of the second flat portion may be in a range of about 0.1 mm to about 0.4 mm.

The upper surface of the first flat portion may be exposed to the outside.

The secondary battery may further include an electrode tab electrically connecting the electrode assembly to a lower surface of the first flat portion.

The vent portion may have a notch in a lower surface thereof.

The vent portion may be inclined from the first flat portion to the second flat portion.

The secondary battery may further include an insulating gasket between the second flat portion and the cylindrical case.

### BRIEF DESCRIPTION OF DRAWINGS

FIG. 1 is a perspective view of a secondary battery according to an embodiment of the present disclosure.

FIG. 2 is a cross-sectional view of the secondary battery shown in FIG. 1.

FIG. 3 is an enlarged cross-sectional view of a cap plate of the secondary battery shown in FIGS. 1 and 2.

FIGS. 4A and 4B are schematic views illustrating steps of a method for manufacturing a cap plate of the secondary battery according to an embodiment of the present disclosure.

### DETAILED DESCRIPTION

Hereinafter, embodiments of the present disclosure will be described, in detail, with reference to the accompanying drawings.

Embodiments of the present disclosure are provided to more completely explain aspects and features of the present disclosure to those skilled in the art, but the following embodiments may be modified in various other forms. Further, the present disclosure may be embodied in many different forms and should not be construed as being limited to the embodiments set forth herein. Rather, these embodiments are provided so that this disclosure will be thorough and complete and will convey the aspects and features of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

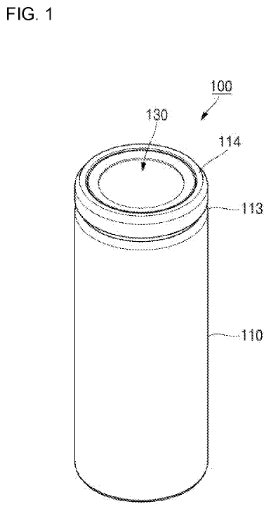

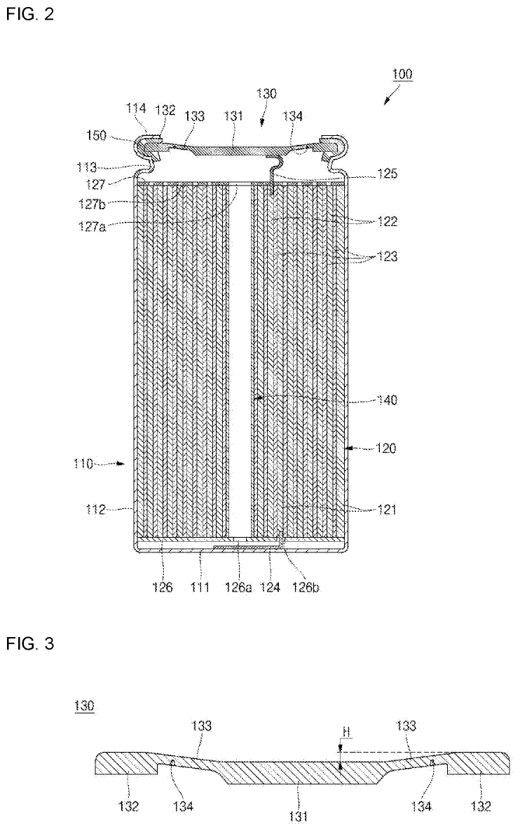

FIG. 1 is a perspective view of a secondary battery according to an embodiment of the present disclosure. FIG. 2 is a cross-sectional view of the secondary battery shown in FIG. 1. FIG. 3 is an enlarged cross-sectional view of a cap plate of the secondary battery shown in FIGS. 1 and 2.

Referring to FIGS. 1 to 3, the secondary battery 100 according to an embodiment of the present disclosure may include a cylindrical case 110, an electrode assembly 120, and a cap plate 130.

The cylindrical case 110 may have a substantially circular bottom portion 111 and a sidewall 112 extending upwardly from the bottom portion 111. In some embodiments, the cylindrical case 110 may include or may be referred to as a can, a casing, or a housing.

During the manufacturing process of the secondary battery, the top portion of the cylindrical case 110 may be open (or opened). Therefore, during the assembling process of the secondary battery, the electrode assembly 120 may be integrated into (e.g., formed into) a single structure and inserted into the cylindrical case 110. In some embodiments, the electrolyte may later be additionally injected into the cylindrical case 110.

The cylindrical case 110 may be made of steel, a steel alloy, nickel-plated steel, a nickel-plated steel alloy, aluminum, or an aluminum alloy.

Additionally, to prevent the cap plate 130 from escaping to the outside (e.g., from being separated from the cylindrical case 110), the cylindrical case 110 may be provided with a beading part (e.g., a bead) 113 recessed inwardly at a lower portion of (e.g., below) the cap plate 130 and a crimping part (e.g., a crimped end) 114 bent inwardly at an upper portion of (e.g., above) the cap plate 130.

The electrode assembly 120 may be accommodated inside the cylindrical case 110. The electrode assembly 120 may include or may be referred to as an electrode, an electrode group, or a jelly roll. The electrode assembly 120 may include a negative electrode plate 121 coated with a negative electrode active material (e.g., graphite, carbon, etc.), a positive electrode plate 122 coated with a positive electrode active material (e.g., transition metal oxide, such as LiCoO₂, LiNiO₂, LiMn₂O₄, etc.), and a separator 123 positioned between the negative electrode plate 121 and the positive electrode plate 122 to prevent a short circuit therebetween while allowing the movement of lithium ions. The negative electrode plate 121, the positive electrode plate 122, and the separator 123 may be wound in a substantially cylindrical shape. In some embodiments, the negative electrode plate 121 may be a copper (Cu) foil, the positive electrode plate 122 may be an aluminum (Al) foil, and the separator 123 may be polyethylene (PE) or polypropylene (PP).

In addition, a negative electrode tab 124 may be welded to the negative electrode plate 121 to protrude and extend downwardly therefrom, and a positive electrode tab 125 may be welded to the positive electrode plate 122 to protrude and extend upwardly thereof. The negative electrode tab 124 may be copper (Cu) or nickel (Ni), and the positive electrode tab 125 may be aluminum (Al).

The negative electrode tab 124 of the electrode assembly 120 may be welded to the bottom portion 111 of the cylindrical case 110. Thus, the cylindrical case 110 may act as a negative electrode. In some embodiments, the negative electrode tab 124 may be ultrasonically welded to or laser welded to the bottom portion 111 of the cylindrical case 110. In other embodiments, the positive electrode tab 125 may be welded to the bottom portion 111 of the cylindrical case 110, and in such an embodiment, the cylindrical case 110 may act as a positive electrode.

A first insulating plate 126 may be interposed between the electrode assembly 120 and the bottom portion 111 and coupled to the cylindrical case 110. The first insulating plate 126 may have a first hole (e.g., a first opening) 126a in the center and a second hole (e.g., a second opening) 126b outside of the first hole 126a (e.g., nearer to an edge of the first insulating plate 126). The first insulating plate 126 prevents the electrode assembly 120 from electrically contacting the bottom portion 111 of the cylindrical case 110. In some embodiments, the first insulating plate 126 prevents the positive electrode plate 122 of the electrode assembly 120 from electrically contacting the bottom portion 111. Further, the first hole 126a allows the gas to quickly move upwardly through a center pin 140 (or a center of the electrode assembly 120) when a large amount of gas is generated due to an abnormality in the secondary battery, and the negative electrode tab 124 passes through the second hole 126b so that it may be welded to the bottom portion 111.

A second insulating plate 127 may be interposed between the electrode assembly 120 and the cap plate 130 and coupled to the cylindrical case 110. The second insulating plate 127 may have a first hole (e.g., a first opening) 127a in the center and a plurality of second holes (e.g., second openings) 127b on the outside thereof (e.g., nearer to an edge of the second insulating plate 127). The second insulating plate 127 prevents the electrode assembly 120 from electrically contacting the cap plate 130. In some embodiments, the second insulating plate 127 prevents the negative electrode plate 121 of the electrode assembly 120 from electrically contacting the cap plate 130. Further, the first hole 127a allows the gas to quickly move to the cap plate 130 when a large amount of gas is generated due to an abnormality in the secondary battery, and at least one of the second holes 127b allows the positive electrode tab 125 to pass through and be welded to the cap plate 130. The remaining second holes 127b allow an electrolyte to quickly flow into the electrode assembly 120 during the electrolyte injection process.

Additionally, the diameters of the first holes 126a and 127a of the first and second insulating plates 126 and 127 are smaller than the diameter of the center pin 140 such that the center pin 140 cannot electrically contact the bottom portion 111 of the cylindrical case 110 or the cap plate 130 due to an external impact.

The center pin 140 has a hollow circular pipe shape and may be coupled to an approximate center of the electrode assembly 120. The center pin 140 may be made of steel, stainless steel, aluminum, an aluminum alloy, or polybutylene terephthalate, but the material is not limited to those listed herein. The center pin 140 suppresses deformation of the electrode assembly 120 during charging and discharging of the secondary battery and acts as a passage for gas generated inside the secondary battery.

The cap plate 130 seals the opening of the cylindrical case 110 to protect the electrode assembly 120 from the external environment, and when the internal pressure of the cylindrical case 110 is higher than a reference pressure (e.g., the operating pressure of the cap plate), the cap plate 130 may be broken (e.g., may burst), and the internal gas of the cylindrical case 110 may be discharged to the outside. In some embodiments, the cap plate 130 may also act as a positive electrode terminal. In some embodiments, the cap plate 130 may be made of aluminum or aluminum alloy.

Referring to FIG. 3, the cap plate 130 may have a first flat portion 131 that is substantially flat and is located at (or forms) the center of the cap plate 130, a second flat portion 132 that is substantially flat and is located outside (e.g., extend around) the first flat portion 131, and a vent portion 133 that is positioned between the first flat portion 131 and the second flat portion 132.

In some embodiments, the cap plate 130 may include or may be referred to as a cap, a conductor plate, a bent plate, a cover, or a lid.

In some embodiments, thicknesses of the first flat portion 131 and the second flat portion 132 may be substantially similar or the same as each other.

The first flat portion 131 is located at the center of the cap plate 130, and the positive electrode tab 125 of the electrode assembly 120 may be welded to a lower portion (or lower surface) thereof. In some embodiments, the lower surface of the first flat portion 131 may be ultrasonically welded to or laser welded to the positive electrode tab 125. In addition, the upper surface of the first flat portion 131 is exposed to the outside and may act as a terminal to be electrically connected to an external device.

The first flat portion 131 may have a thickness in a range of about 0.7 mm to about 0.9 mm. If the thickness of the first flat portion 131 is smaller than about 0.7 mm, a pin hole may be generated (or formed) therein during the welding of the cap plate 130 and the positive electrode tab 125, thereby reducing the bonding force between the two components. In addition, if the thickness of the first flat portion 131 is greater than about 0.9 mm, deformation distribution may occur during the welding of the cap plate 130 and the positive electrode tab 125, thereby degrading the quality of the secondary battery 100.

As such, the secondary battery 100 according to embodiments of the present disclosure provides a secure welding margin by limiting the thickness of the first flat portion 131.

The second flat portion 132 is positioned outside the first flat portion 131 and may be fixed to the cylindrical case 110 through (or by) an insulating gasket 150. The height of the second flat portion 132 (e.g., a height from a bottom surface of the bottom portion 111 of the cylindrical case 110) may be higher than that of the first flat portion 131. An upper surface of the second flat portion 132 may be higher than an upper surface of the first flat portion 131. In other words, the upper surface of the second flat portion 132 and the upper surface of the first flat portion 131 are not located on the same plane. Accordingly, a height difference H exists between the upper surface of the second flat portion 132 and the upper surface of the first flat portion 131 (see, e.g., FIG. 3).

When the second flat portion 132 has a height greater than the first flat portion 131, distribution of the operating pressure of the cap plate 130 may be enhanced and/or improved.

The height difference H between the upper surface of the second flat portion 132 and the upper surface of the first flat portion 131 may be in a range of about 0.1 mm to about 0.4 mm. If the height difference H between the upper surface of the second flat portion 132 and the upper surface of the first flat portion 131 is less than about 0.1 mm or greater than about 0.4 mm, deformation and breaking of a part may occur during operation of the cap plate 130.

In some embodiments, the height difference H between the upper surface of the second flat portion 132 and the upper surface of the first flat portion 131 may be in a range of about 0.15 mm to about 0.35 mm. If the height difference H between the upper surface of the second flat portion 132 and the upper surface of the first flat portion 131 is in the range of about 0.15 mm to about 0.35 mm, the cap plate 130 may not break or deform during operation.

The vent portion 133 may be positioned between the first flat portion 131 and the second flat portion 132. The vent portion 133 may have a thickness that is smaller than the first flat portion 131 and the second flat portion 132. In some embodiments, the vent portion 133 may have a smaller thickness than the first flat portion 131 and the second flat portion 132 by partially removing the lower surface of the cap plate 130 at the vent portion 133. In some embodiments, the vent portion 133 may have a ring shape spaced apart from the center of the cap plate 130.

The vent portion 133 may be provided to be inclined by (e.g., may be inclined to form) the height difference H between the first flat portion 131 and the second flat portion 132. The vent portion 133 may have a notch 134 having a depth (e.g., a predetermined depth) in the lower surface of the vent portion 133. In some embodiments, the notch 134 may have a continuous ring shape formed along the lower surface of the vent portion 133.

When the internal pressure of the secondary battery 100 is (or becomes) greater than the operating pressure of the cap plate 130, the notch 134 in the vent portion 133 is broken (or bursts) so that the gas inside the cylindrical case 110 is released to the outside, thereby improving the safety of the secondary battery 100.

In addition, the secondary battery 100 according to embodiments of the present disclosure seals the upper portion of the cylindrical case 110 with only the cap plate 130 such that other component(s) having a current blocking function (e.g., other insulators) may be omitted, thereby reducing internal resistance and reducing the weight of the secondary battery 100.

The insulating gasket 150 may be interposed between the cap plate 130 and the cylindrical case 110. The insulating gasket 150 may insulate the cap plate 130 and the cylindrical case 110 from each other. In some embodiments, the insulating gasket 150 may cover the outer circumference of the second flat portion 132 of the cap plate 130. The outer surface of the insulating gasket 150 may be in close contact with the beading part 113 and the crimping part 114, and the inner surface of the insulating gasket 150 may be in close contact with the second flat portion 132. In some embodiments, the insulating gasket 150 may include or may be referred to as a sealing gasket, an insulator, or resin.

The insulating gasket 150 may be made of a resin material, such as polyethylene (PE), polypropylene (PP), polyethylene terephthalate (PET), etc., but the insulating gasket 150 is not limited thereto.

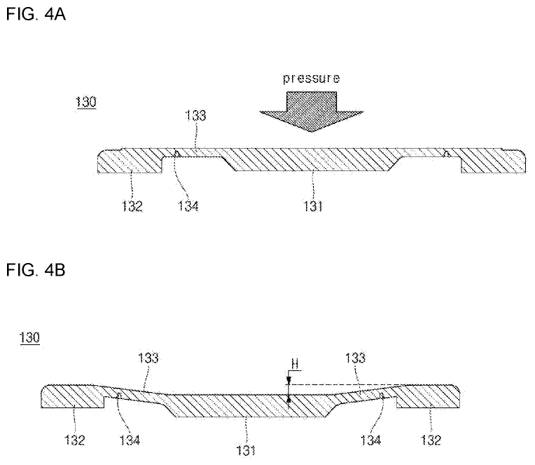

FIGS. 4A and 4B are schematic views illustrating a method for manufacturing a cap plate in the secondary battery 100 according to an embodiment of the present disclosure. As shown in FIGS. 4A and 4B, for example, a cap plate 130 having a first flat portion 131 and a second flat portion 132 positioned on the same plane is provided, and then, pressure is applied to the first flat portion 131 to manufacture the cap plate 130 in which the upper surface of the second flat portion 132 is higher than the upper surface of the first flat portion 131. In some embodiments, by increasing the thickness of a portion of the second flat portion 132 adjacent to the vent portion 133, the thickness of a portion of the second flat portion 132 that may extend (or move) downwardly together with the vent portion 133 when the first flat portion 131 is pressed can be compensated for.

As described above, embodiments of the present disclosure provide a secondary battery exhibiting improved safety by discharging excessive internal gas while preventing deformation of a cap plate, which has a vent portion, when pressure inside the case increases.

The foregoing embodiments are only some embodiments for carrying out the secondary battery according to the present disclosure, which is not limited to the embodiment; thus, it will be understood by a person skilled in the art that various changes in form and details may be made therein without departing from the spirit and scope of the present disclosure as defined by the following claims and their equivalents.

What is claimed is:

1. A secondary battery comprising:
a cylindrical case;
an electrode assembly in the cylindrical case; and
a cap plate electrically connected to the electrode assembly and sealing the cylindrical case, the cap plate having a first flat portion at a center of the cap plate, a second flat portion outside the first flat portion, and a vent portion between the first flat portion and the second flat portion, the vent portion having a thickness smaller than a thickness of the first flat portion or a thickness of the second flat portion.

2. The secondary battery of claim 1, wherein the thickness of the first flat portion is in a range of 0.7 mm to 0.9 mm.

3. The secondary battery of claim 1, wherein an upper surface of the second flat portion is above an upper surface of the first flat portion in a height direction.

4. The secondary battery of claim 3, wherein a height difference between the upper surface of the first flat portion and the upper surface of the second flat portion is in a range of 0.1 mm to 0.4 mm.

5. The secondary battery of claim 3, wherein the upper surface of the first flat portion is exposed to the outside.

6. The secondary battery of claim 1, further comprising an electrode tab electrically connecting the electrode assembly to a lower surface of the first flat portion.

7. The secondary battery of claim 1, wherein the vent portion has a notch in a lower surface thereof.

8. The secondary battery of claim 1, wherein the vent portion is inclined from the first flat portion to the second flat portion.

9. The secondary battery of claim 1, further comprising an insulating gasket between the second flat portion and the cylindrical case.
